(19) United States
(12) Patent Application Publication
(10) Pub. No.: US 2026/0195800 A1
(43) Pub. Date: Jul. 9, 2026

(54) ITEM LIST PROVIDING SYSTEM, SERVER, TERMINAL, ITEM LIST PROVIDING METHOD, AND PROGRAM

(71) Applicant: RAKUTEN GROUP, INC., Tokyo (JP)

(72) Inventor: Kazuhiro SEKINE, Tokyo (JP)

(73) Assignee: RAKUTEN GROUP, INC., Tokyo (JP)

(21) Appl. No.: 19/132,894

(22) PCT Filed: Nov. 16, 2023
(86) PCT No.: PCT/JP2023/041294

§ 371 Date: May 27, 2025

(51) Int. Cl. G06Q 30/0601

(52) U.S. Cl. CPC G06Q 30/0631

(57) ABSTRACT

In an item list providing system (100) including a server (10) and a terminal (20), the server (10) and the terminal (20) perform, in collaboration with each other, processing including: generating a list in which a plurality of items is arranged in an order in which the items are recommended to a user; presenting an item included in the generated list in accordance with an order in which the item is arranged in the list; identifying, when unnecessary-item selection operation of specifying an unnecessary item from the presented items is performed by the user, a low interest item, the low interest item being an item that is similar to the unnecessary item and that has not been presented to the user, among items arranged in the list; and decreasing a priority of the low interest item in the list.

### TECHNICAL FIELD

The present disclosure relates to an item list providing system, a server, a terminal, an item list providing method, and a program.

### BACKGROUND ART

A technology for displaying a product in which a user indicates an interest and a plurality of products related to the product in a recommended product field of a shop or the like open on the Internet has been proposed (for example, Patent Literature 1).

### CITATION LIST

### Patent Literature

Patent Literature 1: Unexamined Japanese Patent Application Publication No. 2008-282098

### SUMMARY OF INVENTION

### Technical Problem

A possibility that when an item such as a product is recommended to a user, an item in which the user is expected to have a low interest is inadvertently viewed by the user is expected to be reduced.

The present disclosure has been made in consideration of the above-described circumstances, and an objective of the present disclosure is to provide an item list providing system and the like capable of suitably recommending an item to a user.

In order to achieve the aforementioned objective, an item list providing system of the present disclosure is an item list providing system including: a server; and a terminal, the item list providing system causing the server and the terminal to perform, in collaboration with each other, processing including:
generating a list in which a plurality of items is arranged in an order in which the items are recommended to a user;
presenting an item included in the generated list in accordance with an order in which the item is arranged in the list to a user;
identifying, when unnecessary-item selection operation of specifying an unnecessary item from the presented items is performed by the user, a low interest item, the low interest item being an item that is similar to the unnecessary item and that has not been presented to the user, among items arranged in the list; and
decreasing a priority of the low interest item in the list.

A server of the present disclosure includes:
a generator to generate a list in which a plurality of items is arranged in an order in which the items are recommended to a user;
a provider to provide a terminal with an item included in the generated list in accordance with an order in which the item is arranged in the list and cause the terminal to display the provided item on a screen of the terminal;
a receiver to receive a report indicating that unnecessary-item selection operation of specifying an unnecessary item from items displayed on the screen is performed in the terminal, from the terminal;
an identifier to identify a low interest item, the low interest item being a similar item similar to the unnecessary item and being a non-displayed item not having been displayed on the screen, among items arranged in the list; and
an updater to decrease a priority of the low interest item in the list.

The report may further include display information indicating which one of items included in the list an item displayed on a screen of the terminal is, and the server may set an item not indicated in the display information as the non-displayed item.

The server may set an item not having been provided to the terminal as the non-displayed item.

The server may newly recommend a new item that is not similar to the unnecessary item and that is not included in the list, and
the server may add the new item between a priority of an item having been provided to the terminal and a priority of the low interest item in the list.

A terminal of the present disclosure includes:
an acquirer to acquire a list in which a plurality of items is arranged in an order in which the items are recommended, from a server;
a display to display the acquired list on a screen in a scrollable manner;
an acceptor to accept unnecessary-item selection operation of specifying an unnecessary item from items arranged in the list and displayed on the screen;
an identifier to identify a low interest item, the low interest item being a similar item similar to the unnecessary item and being a non-displayed item not having been displayed on the screen, among items arranged in the list; and
an updater to decrease a priority of the low interest item in the list.

The terminal, by reporting the unnecessary item to the server, may cause the server to decrease a priority in which the reported item is recommended.

The terminal, by reporting the unnecessary item to the server, may cause the server to identify a similar item similar to the unnecessary item among items arranged in the list.

The terminal may acquire a table of degrees of similarity between items arranged in the list in conjunction with the list, from the server and
the terminal may calculate the degree of similarity between each of the non-displayed items and the unnecessary item from the table.

The terminal may acquire a feature vector of each of items arranged in the list in conjunction with the list, from the server and
the terminal may calculate a degree of similarity between each of the non-displayed items and the unnecessary item, based on the feature vectors.

The terminal, by comparing the calculated degree of similarity with a predetermined threshold value, may identify the similar item or identifies a predetermined number of or a predetermined ratio of items having the calculated degrees of similarity ranked higher as the similar items and the low interest items.

The terminal may cause the server to newly recommend a new item that is not similar to the unnecessary item, and
the terminal may add the new item to the list with a higher priority than the low interest item.

An item list providing method of the present disclosure is an item list providing method in an item list providing system including: a server; and a terminal, the item list providing method causing the server and the terminal to perform, in collaboration with each other, processing including:
generating a list in which a plurality of items is arranged in an order in which the items are recommended to a user;
presenting an item included in the generated list in accordance with an order in which the item is arranged in the list to a user;
identifying, when unnecessary-item selection operation of specifying an unnecessary item from the presented items is performed by the user, a low interest item, the low interest item being an item that is similar to the unnecessary item and that has not been presented to the user, among items arranged in the list; and
decreasing a priority of the low interest item in the list.

A program of the present disclosure is a program causing a computer to function as:
a generator to generate a list in which a plurality of items is arranged in an order in which the items are recommended to a user;
a provider to provide a terminal with an item included in the generated list in accordance with an order in which the item is arranged in the list and cause the terminal to display the provided item on a screen of the terminal;
a receiver to receive a report indicating that unnecessary-item selection operation of specifying an unnecessary item from items displayed on the screen is performed in the terminal, from the terminal;
an identifier to identify a low interest item, the low interest item being a similar item similar to the unnecessary item and being a non-displayed item not having been displayed on the screen, among items arranged in the list; and
an updater to decrease a priority of the low interest item in the list.

Another program of the present disclosure is a program causing a computer to function as:
an acquirer to acquire a list in which a plurality of items is arranged in an order in which the items are recommended;
a display to display the acquired list on a screen in a scrollable manner;
an acceptor to accept unnecessary-item selection operation of specifying an unnecessary item from items arranged in the list and displayed on the screen;
an identifier to identify a low interest item, the low interest item being a similar item similar to the unnecessary item and being a non-displayed item not having been displayed on the screen, among items arranged in the list; and
an updater to decrease a priority of the low interest item in the list.

### Advantageous Effects of Invention

According to the present disclosure, it is possible to suitably recommend an item to a user.

### BRIEF DESCRIPTION OF DRAWINGS

FIG. 1 is a block diagram illustrating a configuration of an item list providing system according to the present embodiment;

FIG. 2 is a diagram illustrating a hardware configuration example of an information processing device constituting the item list providing system according to the present embodiment;

FIG. 3 is a flowchart illustrating an example of recommendation list presentation processing in Embodiment 1;

FIG. 4 is a flowchart illustrating an example of recommendation list generation processing;

FIG. 5 is a diagram illustrating a display example of item information and a recommendation list;

FIGS. 6A to 6D are diagrams illustrating display examples of the recommendation list;

FIG. 7 is a flowchart illustrating an example of recommendation list providing processing in Embodiment 2;

FIG. 8 is a diagram illustrating a method for managing a recommendation list in Embodiment 2;

FIGS. 9A to 9F are diagrams illustrating an update example of a recommendation order of the recommendation list in Embodiment 2;

FIG. 10 is a flowchart illustrating an example of recommendation list display processing in Embodiment 3;

FIG. 11 is a diagram illustrating a method for managing a recommendation list in Embodiment 3; and

FIGS. 12A to 12F are diagrams illustrating an update example of a recommendation order of the recommendation list in Embodiment 3.

### DESCRIPTION OF EMBODIMENTS

An item list providing system 100 according to embodiments of the present disclosure is described below with reference to the drawings. Note that the same or corresponding parts in the drawings are designated by the same reference numerals.

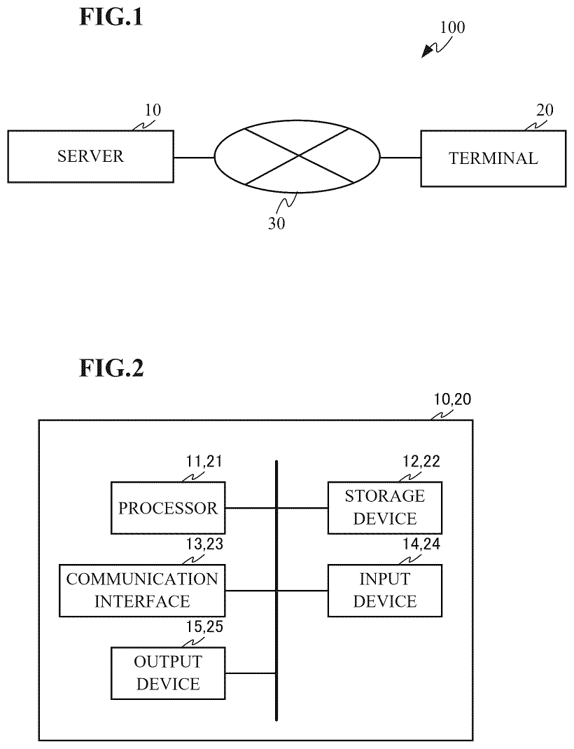

FIG. 1 is a block diagram illustrating a configuration of the item list providing system 100 according to the present embodiment. The item list providing system 100 is a system that presents or provides a recommendation list that is a list of items to be recommended to a user. The item list providing system 100 includes a server 10 and a terminal 20. The server 10 and the terminal 20 are connected to each other via a communication network 30, such as the Internet and a mobile communication network. The server 10 and the terminal 20 transmit and receive information to and from each other via the communication network 30.

The server 10 stores a plurality of pieces of information about predetermined items, generates a recommendation list (recommended item list) that is a list of items arranged in a recommendation order, the recommendation order being an order in which items are recommended to the user, and provides the terminal 20 with the generated recommendation list via the communication network. For example, the server 10 provides, in response to an item view request specifying a specific item or an item view request specifying a search condition from the terminal 20, the terminal 20 with item information of the specified item. In this way, the server 10 also functions as a web server that provides a website the content of which is item information. The server 10 provides the terminal 20 with, in conjunction with item information, a recommendation list in which, for example, items similar to the item are arranged in a recommended order. Since because of this configuration, it is possible to provide the user of the terminal 20 with, in addition to the item information of the specified item, a recommendation list of items recommended based on the item, it becomes possible to provide the user with useful information. Note that an item to be recommended to the user, based on the recommendation list is sometimes referred to as a recommended item.

Although in the embodiment, the server 10 is configured to provide the recommendation list in response to an item view request from the terminal 20 as described above, the server 10 may be configured to provide the user with the recommendation list on another occasion, such as access to a predetermined website and an acquisition request for the recommendation list itself with a condition or the like specified. In addition, the server 10 may be configured to generate a recommendation list (a list of products or the like to be recommended to the user) as an advertisement on a website or a social networking service (SNS) and provide the terminal 20 with the generated recommendation list.

An item is only required to be arbitrary information that the user is to view. For example, an item is only required to be information relating to a product, a service, a used car, a delivery service, digital content of a book, a comic book, a music piece, a video, or the like, an accommodation facility, means of transportation (a train, a bus, an airplane, or the like), a trip, a tour, a restaurant, a recipe, real estate, an aesthetic facility (a beauty salon, aesthetic salon, or the like), a golf course, a recreational facility such as a campground and a fishing boat, a sporting event, or the like or purchase information or reservation information of the foregoing.

The server 10 includes an information processing device capable of performing communication, such as a personal computer (PC) and a workstation. Note that the server 10 may be a dedicated device. In addition, although in FIG. 1, only one server 10 is illustrated, for example, a plurality of servers 10 each of which is used for storing and managing one type of item may be installed.

The terminal 20 is an information processing device having a communication function, such as a smartphone, a tablet, and a PC that the user uses. The terminal 20 transmits an item view request to the server 10 via the communication network 30, based on user operation. The terminal 20 acquires item information and a recommendation list corresponding to the view request that are transmitted from the server 10, based on the item view request. The terminal 20 displays the acquired item information on a screen of the terminal 20. In addition, the terminal 20 enables some of the items in the acquired recommendation list to be viewed at a time successively by, for example, displaying the recommendation list in a scrollable manner on the screen of the terminal 20. Because of this configuration, the user can not only view the item information that the user requested but also view the recommendation list that is a list of items recommended based on the request. Although in FIG. 1, only one terminal 20 is illustrated, the number of terminals 20 can be set to an arbitrary number.

FIG. 2 is a diagram illustrating a hardware configuration example of an information processing device constituting the server 10 and the terminal 20. The server includes a processor 11 such as a central processing unit (CPU) and a graphical processing unit (GPU), a storage device 12 such as a memory and an HDD and/or an SSD, a communication interface 13 that performs wired communication or wireless communication, an input device 14 that accepts input operation, and an output device 15 that performs output of information. The input device 14 is, for example, a keyboard, a touch panel, a camera, a mouse, and/or a microphone. The output device 15 is, for example, a display and/or a speaker.

The storage device 12 of the server 10 stores a plurality of pieces of information about items to be managed. The storage device 12 also stores information (unnecessary item information and recommendation priority information) about each user who accesses the server 10 using the terminal 20. At least a portion of information relating to the user may be stored in a storage device 22 of the terminal 20.

The terminal 20 likewise includes a processor 21, the storage device 22, a communication interface 23, an input device 24, and an output device 25. Note that in the server 10 and the terminal 20, an unnecessary constituent component may be appropriately omitted and another constituent component may be added.

In addition, the item list providing system 100 in the embodiment is configured to be capable of accepting unnecessary-item selection operation of specifying an unnecessary item from items included in the recommendation list presented to the user, from the user. The item list providing system 100 is also configured such that the server 10 and the terminal 20 perform, in collaboration with each other, processing of identifying a low interest item that is similar to a specified unnecessary item and that has not been presented to the user yet and decreasing a recommendation priority of the low interest item in the recommendation list. In the embodiment, the recommendation list is configured such that items included in the list can be successively presented through scrolling or the like and some of the items in the list are presented at a time. Since decreasing a recommendation priority (specifically, display priority in the list) of a low interest item that is similar to an unnecessary item selected based on the unnecessary-item selection operation performed by the user and that has not been presented to the user yet to a lower priority causes a position in an order in which items are presented to the user by scrolling or the like to be moved closer to the end, a low interest item can be made difficult for the user to view. Because of this configuration, a suitable recommendation list matching unnecessary-item selection operation by the user can be presented.

### Embodiment 1

First, Embodiment 1 that is an example of a case where the server 10 and the terminal 20 perform, in collaboration with each other, processing of managing a recommendation list in the entire item list providing system 100 and decreasing a recommendation priority of a low interest item in the recommendation list is described below. In Embodiment 1, an expression “the item list providing system 100 ‘presents’ a recommendation list” is used.

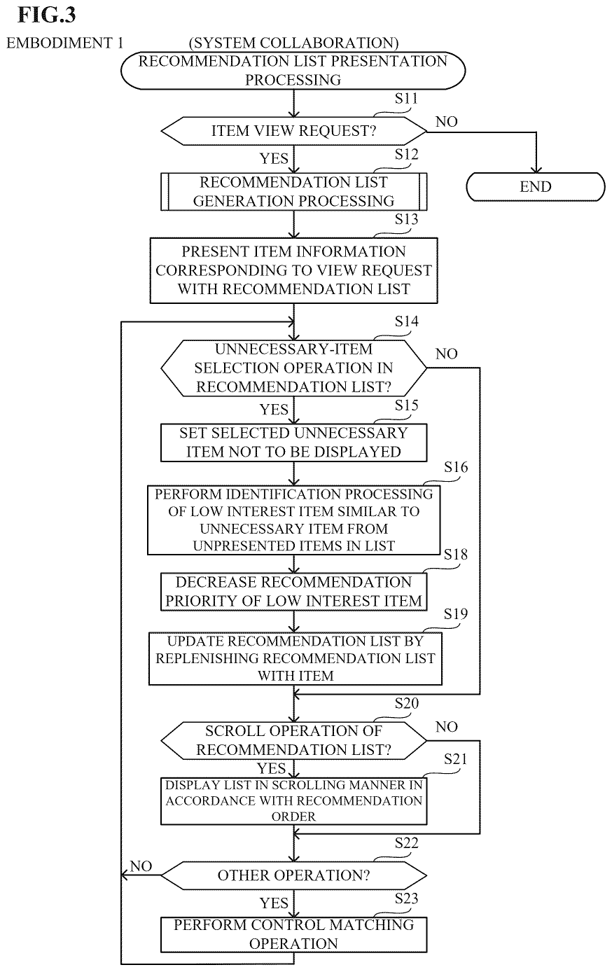

FIG. 3 is a flowchart illustrating an example of recommendation list presentation processing that the item list providing system 100 in Embodiment 1 performs. The recommendation list presentation processing is performed by the processor 11 of the server 10 and the processor 21 of the terminal 20 in collaboration with each other. Specifically, the recommendation list presentation processing is performed by the processor 11 that has read in a program stored in the storage device 12 and the processor 21 that has read in a program stored in the storage device 22. Note that processing in which an execution subject is not particularly specified within a process in FIG. 3 is only required to be performed by at least one of the server 10 and the terminal 20.

In the recommendation list presentation processing, the item list providing system 100 first determines whether or not an item view request to the server 10 has been made by the user (step S11). The item view request made by the user is, for example, operation to view an item performed by the user using the terminal 20. When no item view request has been made by the user (step S11; No), the item list providing system 100 terminates the recommendation list presentation processing.

When an item view request has been made by the user (step S11; Yes), the item list providing system 100 performs recommendation list generation processing for generating a recommendation list to be presented to the user who has made the item view request (step S12).

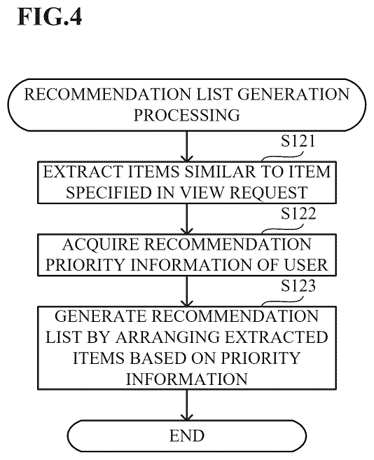

FIG. 4 is a flowchart illustrating an example of the recommendation list generation processing. The recommendation list generation processing is performed by the processor 11 of the server 10. In the recommendation list generation processing, first, the processor 11 extracts an item similar to the item targeted in the item view request made by the user (step S121). In step S121, the processor 11 extracts a predetermined number of items that have attribute information (a category, a manufacturer, conditions, size, color, a region, a price range, or the like) that is the same as or similar to attribute information of the item specified in the view request. Specifically, the processor 11 makes a list of a plurality of items that, although belonging to the same category as the category of the item for which the view request was made, are different from the requested item (for example, an item having a different color or an item manufactured by a different manufacturer). Note that as an algorithm for extracting a similar item, an arbitrary algorithm may be employed.

Next, the processor 11 acquires recommendation priority information of the user who made the item view request (step S122).

Next, the processor 11 generates a recommendation list in which the plurality of items extracted in step S121 is arranged in an order in which the items are recommended to the user, based on the recommendation priority information acquired in step S122 (step S123). Subsequently, the processor 11 terminates the recommendation list generation processing.

The recommendation priority information is information that indicates recommendation priorities of items with respect to each user and is, for example, stored in the storage device 12 of the server 10 in association with identification information of the user. When the user performs unnecessary-item selection operation on the recommendation list presented to the user, the recommendation priority information is updated in such a manner that a recommendation priority of an item selected as an unnecessary item is decreased. The recommendation priority information may be information storing at least unnecessary item information acquired through unnecessary-item selection operation. In addition, for example, when the user performs a predetermined viewing operation of an item, the recommendation priority information is updated in such a manner that the priority of the item is increased.

The recommendation priority information is referred to when a recommendation list is newly generated in step S123, and, for example, the items extracted in step S121 are arranged in the recommendation list in descending order of priority. In addition, the recommendation list is only required to be generated in such a manner that an unnecessary item determined based on past unnecessary-item selection operation performed by the user is prevented from being put into the recommendation list or the recommendation priority of such an unnecessary item is decreased. Because of this configuration, a recommendation list suitable for the user can be generated.

Note that a viewing history of items by the user may be configured to be stored in conjunction with the recommendation priority information. The recommendation list may be configured to be generated with reference to the viewing history of items.

In addition, the recommendation list may be configured to be generated in such a manner that with regard to items the recommendation priorities of which according to the recommendation priority information are not different from one another, the recommendation order in the recommendation list is determined at random or the recommendation order is determined based on information about each item itself, such as a degree of popularity of the item, freshness of the information, and the amount of inventory, or other information. In addition, it may be configured such that when a viewing history of items by the user is referred to, a recommendation priority of an item that has been viewed in the past or an item with a large number of times of viewing is increased.

In addition, for example, in the recommendation list generation processing, a list including items that are expected to be purchased or viewed may be configured to be generated, based on, for example, machine learning, with reference to a trend in products that the user has viewed or purchased in the past, an attribute (age, gender, preference, or the like) of the user himself/herself, a trend in products that another user who has an attribute common to the attribute of the user himself/herself has viewed or purchased, or the like.

When the recommendation list generation processing is completed, the description returns to FIG. 3 and the item list providing system 100 presents the recommendation list generated in step S12 to the user as well as item information corresponding to the view request (step S13). When the view request is a view request in which a specific item is specified, the item information matching the view request is only required to be information about the specific item (for example, a product summary or price information), and when the view request is a view request in which a search condition for an item is specified, the item information matching the view request is only required to be a result of a search for the item (for example, a list or a summary of items satisfying the search condition).

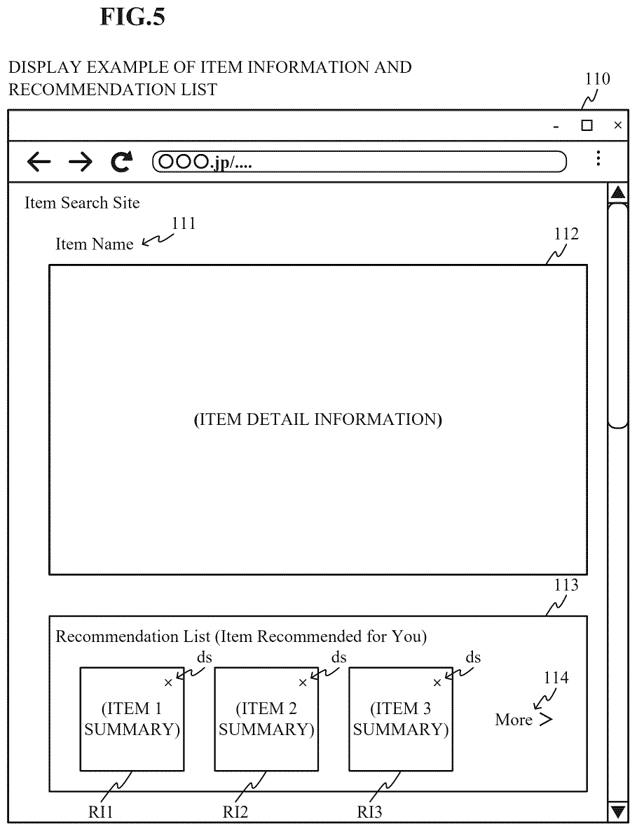

FIG. 5 is a display example of item information and a recommendation list presented by the item list providing system 100. FIG. 5 illustrates, as an example, an example of a case where as a result of the user accessing an item search site and performing viewing operation of a specific item, using a web browser 110 installed in the terminal 20, a web page including item information of the specific item and a recommendation list is displayed on the web browser 110. As illustrated in FIG. 5, on the web browser 110, item information corresponding to viewing operation (view request) of an item, such as an item name 111 and item detail information 112, is displayed. In addition, a recommendation list 113 is displayed in conjunction with the item information. In the recommendation list 113 illustrated in FIG. 5, items the recommendation priorities of which are the top three priorities, such as items RI1, RI2, and RI3, are displayed as recommended items to be recommended to the user. As described above, in the display example illustrated in FIG. 5, three items in the recommendation list generated by the item list providing system 100 are configured to be displayed at a time. For example, in each of the items RI1, RI2, and RI3, a summary of the item is displayed, and each of the items RI1, RI2, and RI3 serves as a link to detail information of the item. In addition, a scroll button 114 to scroll items displayed in the recommendation list 113 is displayed. Although three items are displayed at a time in the recommendation list 113 in FIG. 5, four or more items are included in the recommendation list generated by the item list providing system 100, and operating the scroll button 114 causes some items to be successively displayed at a time in a scrolling manner in accordance with an arrangement order (recommendation order) in the item list.

Next, the item list providing system 100 determines whether or not the user has performed unnecessary-item selection operation with an unnecessary item specified, in the recommendation list presented to the user (step S14).

When the user has performed the unnecessary-item selection operation (step S14; Yes), the item list providing system 100 sets the selected unnecessary item not to be displayed in the recommendation list (step S15). Because of this configuration, an item that is unnecessary for the user can be prevented from being continuously viewable by the user. On this occasion, an item selected in the unnecessary-item selection operation is stored in the recommendation priority information corresponding to the user (for example, an unnecessary item selected in the unnecessary-item selection operation is reported from the terminal 20 to the server 10 and the unnecessary item is stored in the recommendation priority information). Thus, the unnecessary item can be made difficult to recommend or prevented from being recommended to the user thereafter.

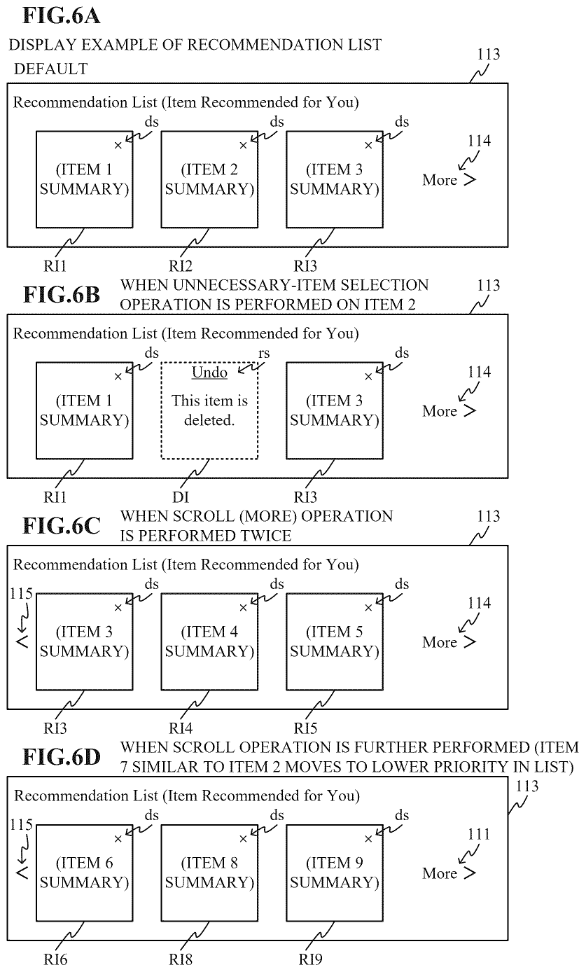

On each of the items RI1, RI2, and RI3 illustrated in FIG. 5, an unnecessary-item selection button ds is displayed. Operation of one of the unnecessary-item selection buttons ds serves as the unnecessary-item selection operation performed on the item and sets the selected item not to be displayed. For example, FIG. 6 is display examples of the recommendation list. For example, when while, as illustrated in FIGS. 5 and 6A, the recommendation priorities that are the top three priorities, the items RI1, RI2, and RI3, are displayed in the recommendation list 113 as default display items, the unnecessary-item selection button ds of the item RI2 is selectively operated (unnecessary-item selection operation), the item RI2 is set not to be displayed and a deleted item DI is displayed at a place where the item RI2 has been displayed, as illustrated in FIG. 6B. Note that an undo button rs is displayed on the deleted item DI and when the undo button rs is operated, the unnecessary-item selection operation is canceled and the item RI2 is redisplayed. Because of this configuration, when an unnecessary-item selection button ds is mistakenly operated or the like, the operation can be canceled. In this case, low-interest-item identification processing and the like succeeding the unnecessary-item selection processing are also not performed. Note that the deleted item DI may be displayed in a form enabling the item to be displayed before deletion to be identified. For example, the item RI2 before deletion may be configured to be faintly or dimly displayed in a background of the deleted item DI.

Next, the item list providing system 100 performs low-interest-item identification processing of identifying a low interest item that is similar to an unnecessary item selected in the unnecessary-item selection operation by the user and that has not been presented to the user, from the items included in the recommendation list (step S16).

In the low-interest-item identification processing, by, for example, comparing an unnecessary item with an item that has not been presented to the user among the other items included in the recommendation list, a similar item to the unnecessary item included in the recommendation list is identified as a low interest item.

As for a method for determining a similar item, a similar item may be determined based on, for example, a degree of commonality in attribute information (a category, a manufacturer, conditions, size, color, a region, a price range, or the like) or may be determined based on, for example, a degree-of-similarity table that is generated by classifying degrees of similarity between items, or the like and that is prepared in advance. Alternatively, a feature vector or a feature amount of an element (image data, text data, or the like) of each item is calculated, and a similar item may be determined based on degrees of similarity between the feature vectors or the feature amounts. That is, a similar item may be identified using an arbitrary method.

In addition, it may be configured such that a degree of similarity is calculated by comparing each of the items included in the recommendation list with the unnecessary item and an item having a degree of similarity within a predetermined threshold value is extracted as a similar item (low interest item). In addition, a predetermined number of or a predetermined ratio of items having calculated degrees of similarity ranked higher may be configured to be extracted as similar items (low interest items).

Whether or not an item in the recommendation list has not been presented is only required to be identified by acquiring a status of viewing of the item through scrolling of the recommendation list or the like in the terminal 20, determining whether the item has been provided from the server 10 to the terminal 20, or the like.

When the item list providing system 100 identifies a low interest item, the item list providing system 100 decreases the recommendation priority of the low interest item in the recommendation list (step S18). Since the item list providing system 100 decreases the recommendation priority of a low interest item that has not been presented to the user yet in the recommendation list in this way, it is possible to reduce a possibility that an item in which the user is expected to have a low interest is inadvertently viewed by the user when the user successively views recommended items.

Next, the item list providing system 100 updates the recommendation list by replenishing the recommendation list with an item to be newly recommended, based on the number of low interest items in the recommendation list (step S19). For example, the item list providing system 100 decreases the recommendation priority of the low interest item to the lowest level in the recommendation list and adds the same number of new recommended items as the number of low interest items to the recommendation list with higher recommendation priorities than the recommendation priorities of the low interest items. In other words, the item list providing system 100 adds an item to be newly recommended between a priority of an item having been presented and a priority of a low interest item. Because of this configuration, the item list providing system 100 can replenish the recommendation list with new items matching the number of low interest items and can recommend the new items with higher priorities than the low interest items. Note that as a method for extracting recommended items with which the recommendation list is replenished, an algorithm similar to the algorithm used in the generation of the recommendation list is only required to be used. For example, the recommendation list is only required to be replenished with a recommended item that is an item not included in the recommendation list that was initially generated, that is an item recommended with the second highest priority, and that is not equivalent to a low interest item.

Note that the number of recommended items with which the recommendation list is replenished is not limited to the same number as the number of low interest items, and may be a predetermined ratio of the number of low interest items or may be larger or smaller than the number of low interest items. In addition, an order in which the recommendation list is replenished with new recommended items may be an arbitrary order.

After the processing in step S19 or when the user has not performed the unnecessary-item selection operation (step S14; No), the item list providing system 100 determines whether or not the user has performed scroll operation on the recommendation list (step S20).

When the user has performed the scroll operation (step S20; Yes), the item list providing system 100 displays the items in the recommendation list in a scrolling manner in accordance with the recommendation order of the recommendation list according to content of the scroll operation (step S21).

For example, when while two items RI1 and RI3 and a deleted item DI are displayed in the recommendation list 113 as illustrated in FIG. 6B, the scroll button 114 is operated twice, the recommendation order of the recommendation list 113 is shifted two steps and items RI3, RI4, and RI5 are displayed, as illustrated in FIG. 6C. When the scroll button 114 is further operated three times, the recommendation order of the recommendation list 113 is shifted three steps, and items RI6, RI8, and RI9 are displayed, as illustrated in FIG. 6D. It is assumed that on this occasion, for example, an item 7 corresponding to an item RI7 is determined to be a low interest item similar to the item 2 corresponding to the item RI2 that was selected as an unnecessary item in the unnecessary-item selection operation and a recommendation priority of the item 7 is thus decreased to the lowest priority. Therefore, the item RI7 that is a summary of the item 7 is not displayed in FIG. 6D. In addition, when the recommendation list 113 is scrolled from the default state, a scroll button 115 to scroll the recommendation list 113 in the reverse direction is displayed, as illustrated in FIGS. 6C and 6D.

Note that although in the embodiment, the recommendation list scrolls in response to operation of the scroll buttons 114 and 115, the recommendation list may be a list that is automatically scrolled (updated) in response to viewing operation of the recommendation list, such as screen scrolling operation. In addition, although in the example illustrated in FIGS. 5 and 6, the recommendation list is configured to scroll in the right and left direction, the recommendation list may be a list that scrolls in the up and down direction or may be a list that scrolls in the up and down direction and the right and left direction.

After the processing in step S21 or when the user has not performed the scroll operation of the recommendation list (step S20; No), the item list providing system 100 determines whether or not the user has performed other operation on the presented item information and the recommendation list (step S22). When the user has performed other operation (step S22; Yes), the item list providing system 100 performs control matching the operation (for example, display control of item information of a selected recommended item) (step S23). When the user has not performed other operation (step S22; No) or after the processing in step S23, the process returns to the processing in step S14.

As described in the foregoing, according to the item list providing system 100 in Embodiment 1, in the item list providing system 100 including the server 10 and the terminal 20, the server 10 and the terminal 20 perform, in collaboration with each other, processing including: generating a list in which a plurality of items is arranged in an order in which the items are recommended to a user; presenting an item included in the generated list in accordance with a recommendation order in which the item is arranged in the recommendation list; identifying, when unnecessary-item selection operation of specifying an unnecessary item from the presented items is performed by the user, a low interest item, the low interest item being an item that is similar to the unnecessary item and that has not been presented to the user, among items arranged in the recommendation list; and decreasing a recommendation priority of the low interest item in the recommendation list.

Since this configuration causes the recommendation priority (display priority) in the recommendation list of an item in which the user is expected to have a low interest to be decreased based on an unnecessary item selected by the user, it is possible to reduce a possibility that an item in which the user is expected to have a low interest is inadvertently viewed by the user when the user successively views recommended items.

In addition, since the recommendation priority of a low interest item is decreased, the other items are displayed in a preferential manner in the recommendation list. Since therefore, the other items are relatively likely to be viewed by the user, a recommendation list in which items in which the user is expected to be highly interested are arranged can be presented.

In addition, since the recommendation order of the recommendation list is changed within items that have not been presented to the user, the recommendation order of the recommendation list can be changed without causing the user to notice the change.

### Embodiment 2

Next, Embodiment 2 that is an example of a case where a server 10 side in an item list providing system 100 mainly performs a process of managing a recommendation list and decreasing a recommendation priority of a low interest item in the recommendation list is described. In Embodiment 2, an expression “the server 10 ‘provides’ a terminal 20 with a recommendation list” is used.

The server 10 in Embodiment 2 generates a recommendation list in which a plurality of items is arranged in an order in which the items are recommended to a user. The server 10 provides the terminal 20 with items included in the generated list in accordance with a recommendation order in which the items are arranged in the recommendation list and causes the terminal 20 to display the provided items on a screen of the terminal 20. The server 10 receives a report indicating that unnecessary-item selection operation of specifying an unnecessary item from the items displayed on the screen is performed in the terminal 20, from the terminal 20. The server 10 identifies, among the items arranged in recommended items, a low interest item that is a similar item similar to the unnecessary item and that is a non-displayed item that has not been displayed yet on the screen of the terminal 20. Further, the server 10 updates the recommendation list by decreasing a priority of display of the low interest item, in the recommendation list.

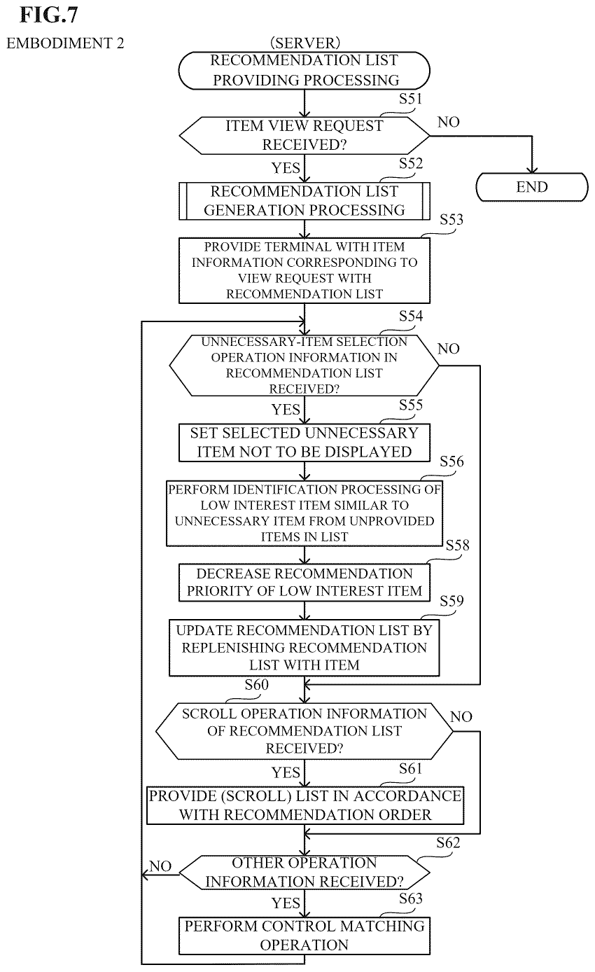

FIG. 7 is a flowchart illustrating an example of recommendation list providing processing that the server 10 in Embodiment 2 performs. The recommendation list providing processing is performed by a processor 11 of the server 10 reading in a program stored in a storage device 12 of the server 10.

In the recommendation list providing processing, the server 10 first determines whether or not the server 10 has received an item view request related to the server 10 made by the user, from the terminal 20 (step S51). The item view request made by the user is transmitted in response to, for example, viewing operation of an item performed using the terminal 20. When the server 10 has not received an item view request (step S51; No), the server 10 terminates the recommendation list providing processing.

When the server 10 has received an item view request (step S51; Yes), the server 10 performs recommendation list generation processing for generating a recommendation list to be provided to the terminal 20 of the user who has made the item view request (step S52). The recommendation list generation processing is only required to be the same as the processing in Embodiment 1 illustrated in FIG. 4. The processing in step S52 is equivalent to a generator of the server 10.

When the server 10 completes the recommendation list generation processing, the server 10 provides the terminal 20 of the user with the recommendation list generated in step S52 in conjunction with item information corresponding to the view request (step S53). The server 10 transmits, for example, data of a web page including the item information and the recommendation list as illustrated in FIG. 5 to the terminal 20. Note that content of the item information corresponding to the view request is, as with Embodiment 1, only required to be information about a specific item or a result of a search for an item. The processing in step S53 is equivalent to a provider of the server 10.

In Embodiment 2, the server 10 is configured to provide the terminal 20 with some of recommended items included in the recommendation list generated by the server 10 at a time. The server 10 generates a recommendation list in which a predetermined number of items are included in the recommendation list generation processing in step S52. The predetermined number may be an arbitrary number and may differ according to the number of similar items extracted in the recommendation list generation processing. The server 10 is configured to provide the terminal 20 with some of the recommended items included in the generated recommendation list at a time. The number of items provided at a time may be an arbitrary number and is only required to be a number less than or equal to the predetermined number. The number of items provided at a time may be a predetermined ratio (for example, 30 percent) of the predetermined number. When scroll operation of the recommendation list is performed on the terminal 20 side and all items that have been provided have been viewed, the server 10 provides items succeeding the previously provided items from the recommendation list.

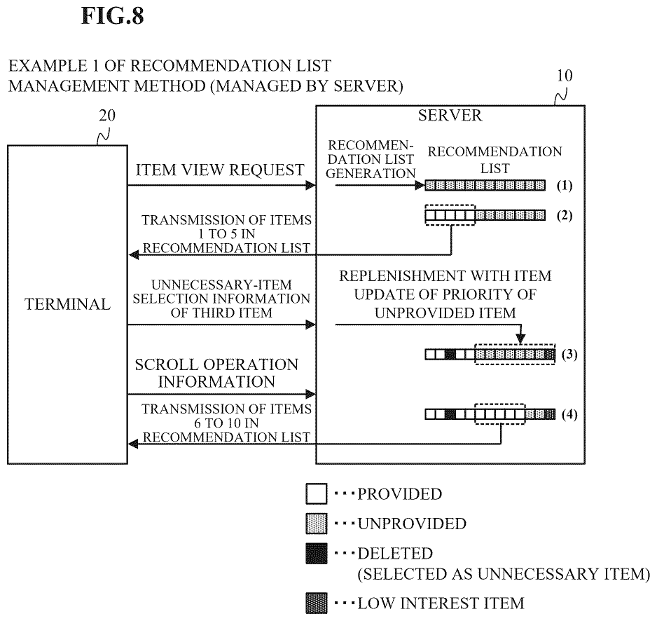

FIG. 8 is a diagram illustrating a method for managing the recommendation list in the server 10. As illustrated in FIG. 8, the server 10 generates a recommendation list in response to an item view request from the terminal 20. In a recommendation list illustrated in FIG. 8, 12 items are included. The server 10 first manages all items included in the generated recommendation list with statuses of the items set to “unprovided” (unprovided to the terminal 20) (portion (1) of FIG. 8).

The server 10 provides the terminal 20 with some items included in the recommendation list.

In FIG. 8, the server 10 provides the terminal 20 with items 1 to 5 the recommendation priorities of which are the top five priorities in the recommendation list. The server 10 updates the statuses of the items to “provided” (provided to the terminal 20) (portion (2) of FIG. 8).

Next, the server 10 determines whether or not the server 10 has received unnecessary-item selection operation information indicating that the user has performed unnecessary-item selection operation of specifying an unnecessary item in the recommendation list provided to the user, from the terminal 20 (step S54). The unnecessary-item selection operation information serves as a report indicating that unnecessary-item selection operation from the terminal 20 is performed. The processing in step S54 is equivalent to a receiver of the server 10.

When the server 10 has received unnecessary-item selection operation information from the terminal 20 (step S54; Yes), the server 10 sets a selected unnecessary item not to be displayed in the recommendation list (step S55). For example, the server 10 updates the recommendation list displayed on the terminal 20 by transmitting data of a web page in which a portion where the unnecessary item has been displayed is updated to a non-display item (for example, the deleted item DI illustrated in FIG. 6B) to the terminal 20.

Because of this configuration, an item that is unnecessary for the user can be prevented from being continuously viewable by the user. On this occasion, an item selected in the unnecessary-item selection operation is stored in the storage device 12 of the server 10. Specifically, the item selected in the unnecessary-item selection operation is stored in recommendation priority information corresponding to the user and updated as an unnecessary item. Thus, the unnecessary item can be made difficult to recommend or prevented from being recommended to the user thereafter.

The server 10 performs low-interest-item identification processing of identifying a low interest item that is similar to an unnecessary item selected in the unnecessary-item selection operation by the user and that has not been provided to the user, from the items included in the recommendation list (step S56). The processing in step S56 is equivalent to an identifier of the server 10.

In the low-interest-item identification processing, the server 10, for example, compares an unnecessary item with other items included in the recommendation list and identifies a similar item to the unnecessary item included in the recommendation list.

As for a method for determining a similar item, a similar item may be determined based on, for example, a degree of commonality in attribute information (a category, a manufacturer, conditions, size, color, a region, a price range, or the like) or may be determined based on, for example, a degree-of-similarity table that is generated by classifying degrees of similarity between items, or the like and that is prepared in advance. Alternatively, a feature vector or a feature amount of an element (image data, text data, or the like) of each item is calculated, and a similar item may be determined based on degrees of similarity between the feature vectors or the feature amounts. That is, a similar item may be identified using an arbitrary method.

In addition, the server 10 may be configured to calculate a degree of similarity by comparing each of the items included in the recommendation list with the unnecessary item and extract an item having a degree of similarity within a predetermined threshold value as a similar item (low interest item). In addition, a predetermined number of or a predetermined ratio of items having calculated degrees of similarity ranked higher may be configured to be extracted as similar items (low interest items).

An item that has not been provided from the server 10 to the terminal 20 apparently has not been displayed on the terminal 20 and has not been viewed by the user yet. Thus, in step S56, the server 10, by considering an unprovided item as an approximation of a non-displayed item, identifies a low interest item from the unprovided items. Since because of this configuration, the server 10 does not need to acquire a viewing status of each recommended item from the terminal 20, a processing load can be reduced.

On the other hand, a case is conceivable where the number of recommended items provided from the server 10 to the terminal 20 at one time is not the same as the number of recommended items displayed on the terminal 20 at one time. For example, when the number of recommended items displayable on the terminal 20 at one time is smaller than the number of recommended items provided from the server 10 to the terminal 20 at one time, an item that has been provided to the terminal 20 and that has not been displayed on the terminal 20 apparently exists. In this case, the server 10 may be configured to acquire display information indicating whether or not the terminal 20 actually displayed each item and identify a low interest item from items that have not been displayed, based on the display information. In this case, an item that has been provided to the terminal 20 and that has not been displayed on the terminal 20 is a low interest item, and when a portion of the recommendation list including the low interest item is updated, the server 10 is only required to transmit the updated recommendation list to the terminal 20.

When the server 10 identifies a low interest item, the server 10 decreases the recommendation priority of the low interest item in the recommendation list (step S58). The server 10 updates the recommendation list by replenishing the recommendation list with an item to be newly recommended, based on the number of low interest items in the recommendation list (step S59). The server 10 adds the item to be newly recommended between a priority of an item having been presented and a priority of a low interest item. Note that the processing in steps S58 and S59 is the same as the processing in steps S18 and S19 in Embodiment 1, respectively. The processing in steps S58 and S59 is equivalent to an updater of the server 10.

For example, when at a stage where the server 10 has provided the terminal 20 with the items 1 to 5 included in the recommendation list as illustrated in portion (2) of FIG. 8, unnecessary-item selection operation information is transmitted with respect to a third item from the terminal 20 to the server 10, the server 10 identifies an item similar to the third item as a low interest item from sixth to twelfth items that have not been provided in the recommendation list. The server 10 decreases the recommendation priority of the identified low interest item to the lowest priority. On this occasion, the server 10 replenishes the recommendation list with the same number of recommended items as the number of low interest items at higher priorities than the low interest items (for example, at a priority one priority higher than a low interest item). As described above, the recommendation list can be updated in response to unnecessary-item selection operation performed by the user and a recommendation list suitable for the user can be successively provided, on the server 10 side. In addition, the server 10 updates a status of the third item selected in the unnecessary-item selection operation to “deleted” and updates a status of the low interest item to “low interest item” (portion (3) of FIG. 8).

After the processing in step S59 or when the server 10 has not received unnecessary-item selection operation information from the terminal 20 (step S54; No), the server 10 determines whether or not the server 10 has received scroll operation information indicating that the user has performed scroll operation on the recommendation list from the terminal 20 (step S60).

When the server 10 has received scroll operation information (step S60; Yes), the server 10 causes the terminal 20 to display items in the recommendation list displayed on the screen of the terminal 20 in a scrolling manner in accordance with the recommendation order of the recommendation list according to content of the scroll operation information (step S61). For example, the server 10 updates the recommendation list to be displayed on the terminal 20 by transmitting data of a web page in which the recommendation list is updated by scrolling the recommendation list in accordance with the recommendation order to the terminal 20.

For example, when at a stage where the server 10 has provided the terminal 20 with the items 1 to 5 included in the recommendation list as illustrated in portion (3) of FIG. 8, the server 10 receives scroll operation information with respect to a sixth item and subsequent items from the terminal 20, the server 10 provides the terminal 20 with items 6 to 10 with recommendation priorities at sixth to tenth positions from the top. By the configuration as described above, the server 10 can successively provide the terminal 20 with recommended items. The server 10 updates statuses of the newly provided items to “provided” (provided to the terminal 20) (portion (4) of FIG. 8).

After the processing in step S61 or when the server 10 has not received scroll operation information of the recommendation list from the terminal 20 (step S60; No), the server 10 determines whether or not the server 10 has received other operation information indicating that the user has performed another type of operation on the provided item information and recommendation list from the terminal 20 (step S62). When the server 10 has received other operation information from the terminal 20 (step S62; Yes), the server 10 performs control matching the operation information (for example, display control of item information of a selected recommended item or update control of a web page) (step S63). When the server 10 has not received other operation information from the terminal 20 (step S62; No) or after the processing in step S63, the process returns to the processing in step S54.

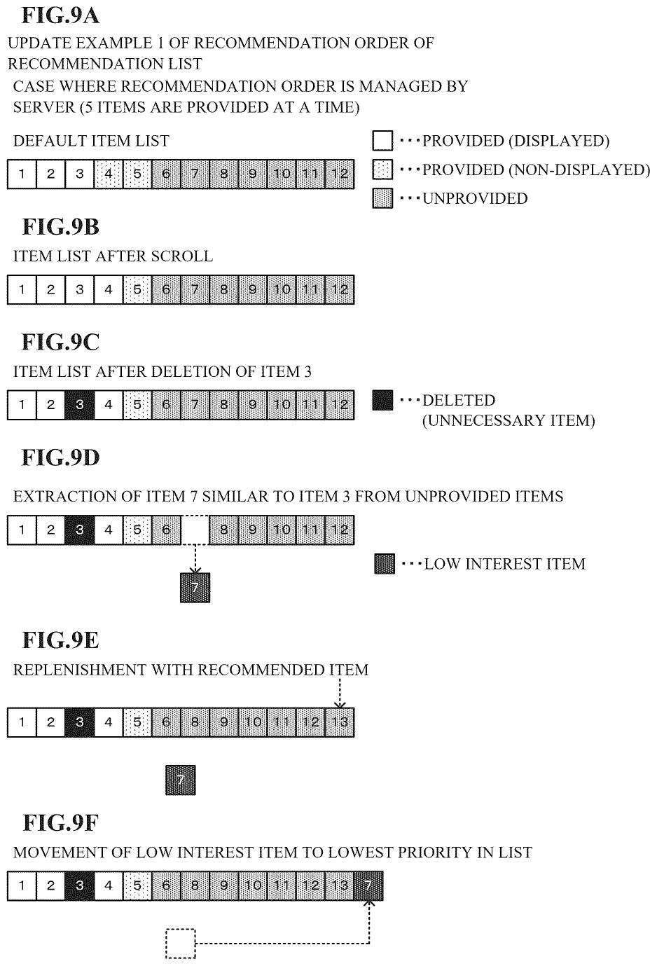

FIG. 9 is a diagram illustrating an example of a case where the recommendation order of the recommendation list generated in the server 10 is updated. A case where, for example, a recommendation list including items 1 to 12 is generated in the server 10 is described. The server 10, for example, provides five recommended items at a time. Immediately after the recommendation list is generated, the items 1 to 5 are brought into a state of having been provided to the terminal 20, as illustrated in FIG. 9A. When the terminal 20 displays three items at a time, the items 1 to 3 are brought into a state of having been displayed to the user and the items 4 and 5 are brought into a state of not having been displayed, as illustrated in FIG. 9A.

Subsequently, when, for example, the recommendation list is scrolled one item to the right by the user, the item 4 is brought into a state of having been displayed, as illustrated in FIG. 9B.

In this step, when, for example, unnecessary-item selection operation is performed with respect to the item 3 by the user, the item 3 is deleted and becomes an unnecessary item, as illustrated in FIG. 9C.

An item similar to the unnecessary item selected in the unnecessary-item selection operation is identified from the items 6 to 12, which are unprovided items, and, for example, the identified item 7 is extracted as a low interest item, as illustrated in FIG. 9D.

Subsequently, as illustrated in FIG. 9E, the recommendation list is replenished with an item 13, the number of which is the same as the number of extracted low interest items, as a recommended item at a priority before the priority of the low interest item, and the item 7, which is a low interest item, moves to the lowest priority in the recommendation list, as illustrated in FIG. 9F.

As described above, in accordance with operation on the recommendation list in the terminal 20, the recommendation list is flexibly updated in the server 10. The updated recommendation list is to be supplied to the terminal 20 in response to acquisition operation of a new item, such as scroll operation, performed in the terminal 20. Because of this configuration, when the user successively views recommended items, the recommended items can be suitably supplied to the user. Specifically, a possibility that an item in which the user is expected to have low interest is inadvertently viewed by the user can be reduced.

As described in the foregoing, according to the server 10 in Embodiment 2, the server 10 performs processing including: generating a recommendation list in which a plurality of items is arranged in an order in which the items are recommended to a user; providing the terminal 20 with an item included in the generated recommendation list in accordance with a recommendation order in which the item is arranged in the recommendation list and causing the terminal 20 to display the provided item on a screen of the terminal 20; receiving a report indicating that unnecessary-item selection operation of specifying an unnecessary item from items displayed on the screen is performed in the terminal 20, from the terminal; identifying a low interest item, the low interest item being a similar item similar to the unnecessary item and being a non-displayed item not having been displayed on the screen, among items arranged in the recommendation list; and decreasing a priority of the low interest item in the recommendation list.

Because of this configuration, the recommendation priority (display priority) in the recommendation list of an item in which the user is expected to have a low interest can be decreased mainly by the server 10 side, based on the unnecessary item selected by the user, and recommended items can be provided to the terminal 20 from the recommendation list. Thus, it is possible to reduce a possibility that an item in which the user is expected to have a low interest is inadvertently viewed by the user when the user successively views recommended items.

In addition, since the recommendation priority of a low interest item is decreased, the other items are displayed in a preferential manner in the recommendation list. Since therefore, the other items are relatively likely to be viewed by the user, a recommendation list in which items in which the user is expected to be highly interested are arranged can be provided.

In addition, since the recommendation order of the recommendation list is changed within items that have not been provided to the user, the recommendation order of the recommendation list can be changed without causing the user to notice the change.

### Embodiment 3

Next, Embodiment 3 that is an example of a case where a terminal 20 side in an item list providing system 100 mainly performs a process of managing a recommendation list and decreasing a recommendation priority of a low interest item in the recommendation list is described. In Embodiment 2, an expression “the terminal 20 ‘displays’ a recommendation list on a screen” is used.

The terminal 20 in Embodiment 3 collectively acquires a recommendation list in which a plurality of items is arranged in an order in which the items are recommended and that is generated by a server 10. The terminal 20 displays the acquired list on a screen in a scrollable manner. The terminal 20 accepts unnecessary-item selection operation of specifying an unnecessary item from items arranged in the recommendation list and displayed on the screen. The terminal 20 identifies, among the items arranged in the recommendation list, a low interest item that is a similar item similar to the unnecessary item and that is a non-displayed item that has not been displayed yet on the screen. The terminal 20 updates the recommendation list by decreasing a priority of the low interest item in the recommendation list.

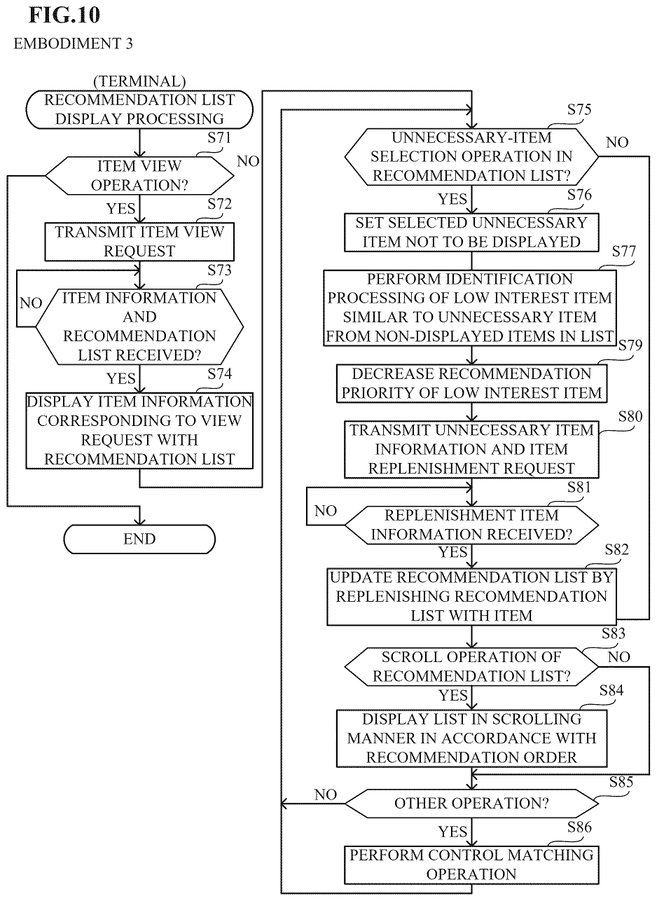

FIG. 10 is a flowchart illustrating an example of recommendation list display processing that the terminal 20 in Embodiment 3 performs. The recommendation list display processing is performed by a processor 21 of the terminal 20 reading in a program stored in a storage device 22.

In the recommendation list display processing, the terminal 20 first determines whether or not the terminal 20 has detected viewing operation of an item performed by a user (step S71). Examples of the viewing operation of an item performed by the user include viewing of an item provided by the server 10, access to a website for search, or selection operation or search operation of item information using the website. When the terminal 20 has not detected viewing operation of an item (step S71; No), the terminal 20 terminates the recommendation list display processing.

When the terminal 20 has detected viewing operation of an item (step S71; Yes), the terminal 20 transmits an item view request for the server matching the viewing operation performed by the user, to the server (step S72). Next, the terminal 20 waits until receiving item information corresponding to the item view request from the server and a recommendation list accompanying the item information (step S73). Note that the recommendation list is generated by performing recommendation list generation processing illustrated in FIG. 4, or the like in the server 10. The processing in step S73 is equivalent to an acquirer of the terminal 20.

When the terminal 20 receives the item information and the recommendation list from the server (step S73; Yes), the terminal 20 displays the received item information and recommendation list in the screen (step S74). The terminal 20 displays, for example, data of a web page including the item information and the recommendation list as illustrated in FIG. 5. Note that content of the item information is, as with Embodiment 1, only required to be information about a specific item or a result of a search for an item. The processing in step S74 is equivalent to a display of the terminal 20.

In Embodiment 3, the terminal 20 is configured to display some of recommended items included in the recommendation list, which was collectively received from the server 10, at a time. The server 10 generates a recommendation list in which a predetermined number of items are included, the predetermined number being an arbitrary number. The terminal 20 is configured to display some of the recommended items included in the received recommendation list on the terminal 20 at a time. The number of items displayed at a time may be an arbitrary number and is only required to be a number less than or equal to the predetermined number. The number of items displayed at a time may be a predetermined ratio (for example, 30 percent) of the predetermined number. When scroll operation of the recommendation list is performed in the terminal 20 and all items that have been displayed have been viewed, the terminal 20 displays an item succeeding the displayed items from the recommendation list.

FIG. 11 is a diagram illustrating a method for managing the recommendation list in the terminal 20. As illustrated in FIG. 11, the terminal 20 transmits an item view request to the server 10 in response to viewing operation of an item performed by the user. The server 10 generates a recommendation list in response to the view request and collectively transmits the generated recommendation list to the terminal 20. On this occasion, the server 10 determines degrees of similarity between recommended items included in the recommendation list and also transmits similarity information between recommended items that is a result of the determination. In a method for determining degrees of similarity between recommended items, as with the above-described embodiments, degrees of similarity between recommended items are only required to be determined based on degrees of similarity between pieces of attribute information, degrees of similarity between feature vectors or feature amounts, or the like. Thus, the similarity information may be a degree-of-similarity table generated by classifying degrees of similarity of items or may be information indicating feature vectors of the items. Transmitting the similarity information in advance in this way makes it unnecessary to calculate degrees of similarity between recommended items on the terminal 20 side and enables a processing load on the terminal 20 to be reduced and speeding-up of processing to be achieved.

In a recommendation list transmitted from the server 10 and illustrated in FIG. 11, 12 items are included. The terminal 20 displays some (for example, three) of the items included in the recommendation list on the terminal 20 at a time. In FIG. 11, the terminal 20 displays items 1 to 3 the recommendation priorities of which are the top three priorities in the recommendation list. The terminal 20 manages items by setting statuses of displayed items to “displayed” (displayed on the terminal 20) and statuses of the other items to “non-displayed” (not displayed on the terminal 20) (portion (1) of FIG. 11).

Next, the terminal 20 determines whether or not the terminal 20 has accepted that the user performed unnecessary-item selection operation of specifying an unnecessary item in the displayed recommendation list (step S75). The processing in step S75 is equivalent to an acceptor of the terminal 20.

When the terminal 20 has accepted unnecessary-item selection operation (step S75; Yes), the terminal 20 sets a selected unnecessary item not to be displayed in the recommendation list (step S76). For example, the terminal 20 updates the recommendation list by setting a portion where the unnecessary item has been displayed (for example, a deleted item DI illustrated in FIG. 6B) not to be displayed. Because of this configuration, an item that is unnecessary for the user can be prevented from being continuously viewable by the user. On this occasion, an item selected in the unnecessary-item selection operation is stored in the storage device 22 of the terminal 20. Specifically, the item selected in the unnecessary-item selection operation is stored in recommendation priority information corresponding to the user and updated, as an unnecessary item. Thus, the unnecessary item can be made difficult to recommend or prevented from being recommended to the user thereafter.

The terminal 20 performs low-interest-item identification processing of identifying a low interest item that is similar to an unnecessary item selected in the unnecessary-item selection operation by the user and that has not been displayed to the user from the items included in the recommendation list (step S77). The processing in step S77 is equivalent to an identifier of the terminal 20.

In the low-interest-item identification processing, the terminal 20, by, for example, comparing the unnecessary item with an item that has not been displayed to the user among the other items included in the recommendation list, identifies a similar item to the unnecessary item included in the recommendation list as a low interest item. The similar item to the unnecessary item is only required to be identified based on similarity information (a degree-of-similarity table, feature vectors, or the like) received from the server 10 in conjunction with the recommendation list. For example, it may be configured such that, based on the similarity information, a degree of similarity is calculated by comparing each of the items included in the recommendation list with the unnecessary item and an item having a degree of similarity within a predetermined threshold value is extracted as a similar item (low interest item). In addition, a predetermined number of or a predetermined ratio of items having calculated degrees of similarity ranked higher may be configured to be extracted as similar items (low interest items).

Note that it may be configured such that when the terminal 20 detects unnecessary-item selection operation, the terminal 20 transmits information about a selected unnecessary item to the server 10 and causes the server 10 to perform the similar item identification and the low interest item identification. As a method for determining a similar item in the server, for example, the method in Embodiment 2 is only required to be employed. In this case, the terminal 20 does not have to acquire the similarity information from the server 10 in advance.

In addition, when the terminal 20 does not receive similarity information in advance, the terminal 20 may be configured to acquire similarity information between recommended items when the terminal 20 detects the unnecessary-item selection operation. In addition, the terminal 20 may be configured to acquire a degree-of-similarity table at a timing other than a recommendation list acquisition timing.

An item that has not been displayed on the terminal 20 has apparently not been viewed by the user. In the embodiment, in order to change a recommendation priority of an item that has not been viewed by the user in the recommendation list as described above, the terminal 20 identifies a low interest item from the items that have not been displayed, in step S77.

When the terminal 20 identifies a low interest item, the terminal 20 decreases a recommendation priority of the low interest item in the recommendation list (step S79). The processing in step S79 is the same as the processing in step S18 in Embodiment 1. The processing in step S79 is equivalent to an updater of the terminal 20.

Next, the terminal 20 transmits unnecessary item information that is information about an item selected as an unnecessary item and an item replenishment request requesting replenishment of the recommendation list with an item to be newly recommended based on the number of low interest items in the recommendation list, to the server 10 (step S80). By transmitting the unnecessary item information to the server 10, the terminal 20 can cause the recommendation priority information of each user to be updated in the server 10, based on the unnecessary item information. Unnecessary-item selection operation information serves as a report of an unnecessary item from the terminal 20 to the server 10. Since the recommendation priority information is referred to in the server 10 when a recommendation list is newly generated and the server 10 generates a recommendation list by decreasing a recommendation priority of an unnecessary item based on past unnecessary-item selection operation performed by the user, a recommendation list suitable for the user can be generated. That is, by a report of an unnecessary item from the terminal 20, the terminal 20 can cause the server 10 to decrease a priority in which the reported item is recommended.

Subsequently, the terminal 20 waits until receiving replenishment item information corresponding to the item replenishment request, from the server 10 (step S81). The item replenishment request includes, for example, the recommendation list and information enabling the number of low interest items to be identified.

When the server 10 receives the item replenishment request from the terminal 20, the server 10 extracts a new recommended item with which the recommendation list is replenished and transmits item information of the extracted recommended item to the terminal 20. For example, the server 10 is only required to extract the same number of new recommended items as the number of low interest items. As a method for extracting an item with which the recommendation list is replenished, an algorithm similar to the algorithm used in the generation of the recommendation list is only required to be used. For example, the recommendation list is only required to be replenished with a recommended item that is an item not included in the recommendation list that was initially generated, that is an item recommended with the second highest priority, and that is not equivalent to a low interest item.

When the terminal 20 receives replenishment item information corresponding to the item replenishment request from the server 10 (step S81; Yes), the terminal 20 replenishes the recommendation list with an item corresponding to the received replenishment item information as an item to be newly recommended and updates the recommendation list (step S82). In step S82, for example, the terminal 20 decreases a recommendation priority of a low interest item to the lowest priority in the recommendation list and adds a new recommended item to the recommendation list at a higher recommendation priority than the low interest item. In other words, the terminal adds the item to be newly recommended between a priority of an item having been presented and a priority of a low interest item. Because of this configuration, the item list providing system 100 can replenish the recommendation list with new items matching the number of low interest items and can recommend the new items with higher priorities 20 than the low interest items.

After the processing in step S82 or when the terminal 20 has not received unnecessary-item selection operation information (step S75; No), the terminal 20 determines whether or not the terminal 20 has detected that the user has performed scroll operation on the recommendation list (step S83).

When the terminal 20 has detected scroll operation (step S83; Yes), the terminal 20 displays items in the recommendation list displayed on a screen of the terminal 20 in a scrolling manner in accordance with a recommendation order of the recommendation list according to content of the scroll operation (step S84). For example, the terminal 20 updates the recommendation list displayed on the terminal 20 by displaying data from a web page in which the recommendation list is updated by scrolling the recommendation list in accordance with the recommendation order.

After the processing in step S84 or when the terminal 20 has not detected scroll operation of the recommendation list (step S83; No), the terminal 20 determines whether or not the terminal 20 has detected that the user has performed other operation on the displayed item information and the recommendation list (step S85). When the terminal 20 has detected other operation (step S85; Yes), the terminal 20 performs control matching the detected operation (for example, display control of item information of a selected recommended item or update control of a web page) (step S86). When the terminal 20 has not detected other operation (step S85; No) or after the processing in step S86, the process returns to the processing in step S75.

In Embodiment 3, when at a stage where items 1 to 3 included in the recommendation list are displayed on the terminal 20 as illustrated in portion (1) of FIG. 11, for example, scroll operation to view a fourth item on the terminal 20 is performed, the terminal 20 updates a status of the displayed item to “displayed” (displayed on the terminal 20) (portion (2) of FIG. 11). Note that in the embodiment, since three items in the recommendation list are displayed at a time as illustrated in FIG. 5, the items 2 to 4 are caused to be displayed on the terminal 20 after the scroll operation.

In addition, for example, when at a stage where the items 2 to 4 included in the recommendation list are displayed on the terminal 20 as illustrated in portion (2) of FIG. 11, unnecessary-item selection operation is performed with respect to the third item, the terminal 20 sets the third item not to be displayed and updates a status of the third item selected in the unnecessary-item selection operation to “deleted”.

When unnecessary-item selection operation is performed in the terminal 20, unnecessary item information and an item replenishment request are transmitted to the server 10. In addition, the terminal 20 identifies an item similar to the third item from fifth to twelfth items that have not been displayed in the recommendation list as a low interest item. The terminal 20 updates a status of the identified low interest item to “low interest item” (portion (4) of FIG. 11). In portion (4) of FIG. 11, the fifth and eighth items are identified as low interest items.

The terminal 20 updates the recommendation list by decreasing a recommendation priority of the identified low interest item to the lowest priority and replenishing the recommendation list with an item (in this example, two items) corresponding to replenishment item information received from the server 10 at a priority higher than the priority of the low interest item (for example, at a priority one priority higher than the low interest item) (portions (5) and (6) of FIG. 11). As described above, in Embodiment 3, the recommendation list can be updated in response to unnecessary-item selection operation performed by the user, and a recommendation list suitable for the user can be successively displayed, on the terminal 20 side.

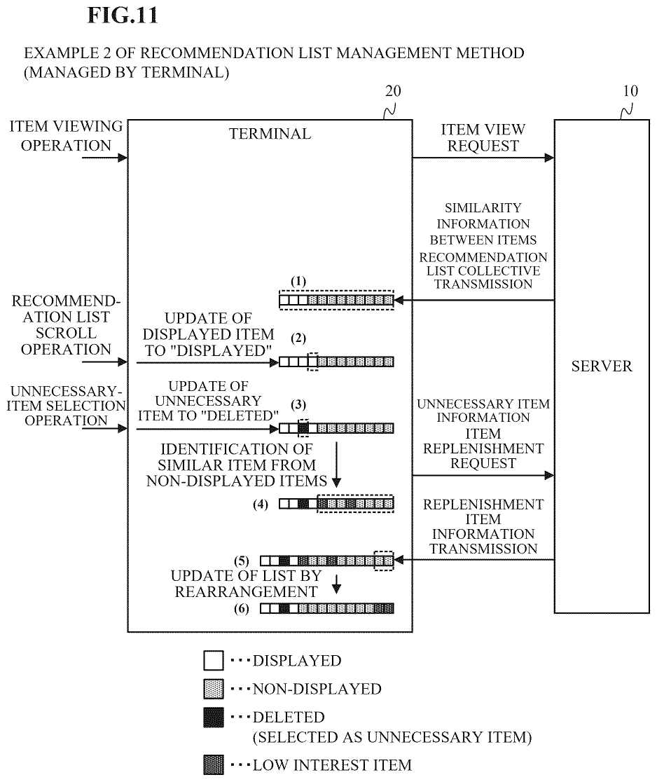

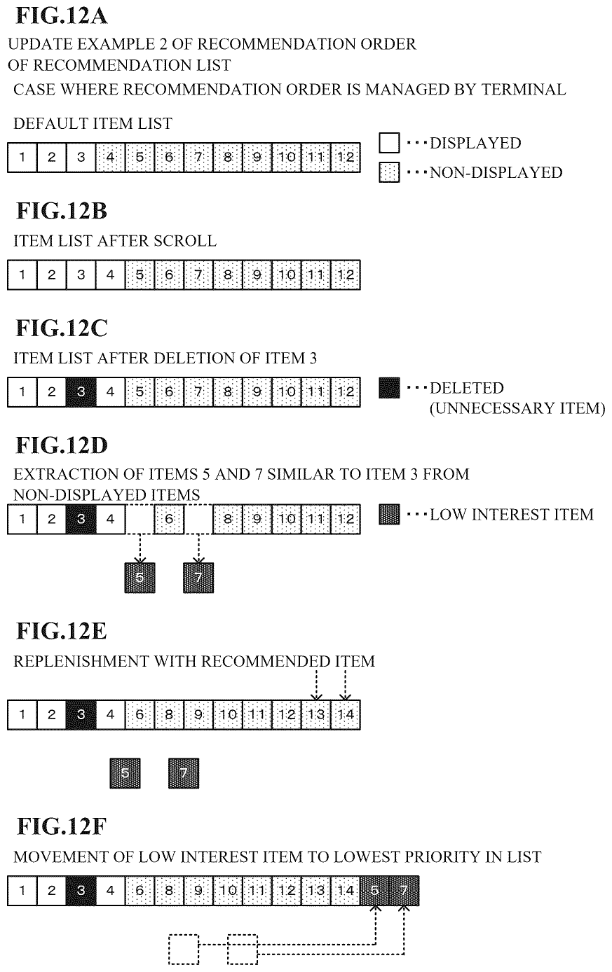

FIG. 12 is a diagram illustrating an example of a case where the recommendation order of the recommendation list is updated in the terminal 20. A case where, for example, a recommendation list including items 1 to 12 is generated in the terminal 20 is described. The terminal 20, for example, displays three recommended items at a time. Immediately after the recommendation list is collectively received from the server 10, statuses of the items 1 to 3 are set to “displayed” on the terminal 20 and statuses of the items 4 to 12 are set to “non-displayed”, as illustrated in FIG. 12A.

Subsequently, when, for example, the recommendation list is scrolled one item to the right by the user, a status of the item 4 is changed to “displayed”, as illustrated in FIG. 12B.

On this occasion, when, for example, unnecessary-item selection operation is performed with respect to the item 3 by the user, the item 3 is deleted and becomes an unnecessary item, as illustrated in FIG. 12C.

An item similar to the unnecessary item selected in the unnecessary-item selection operation is identified from the items 5 to 12, which are non-displayed items, and, for example, identified items 5 and 7 are extracted as low interest items, as illustrated in FIG. 12D.

Subsequently, as illustrated in FIG. 12E, the recommendation list is replenished with items 13 and 14, the number of which is the same as the number of extracted low interest items, from the server 10 as recommended items at priorities before priorities of the low interest items, and the items 5 and 7, which are low interest items, moves to the lowest priority in the recommendation list, as illustrated in FIG. 12F.

As described above, the recommendation list is flexibly updated in the terminal 20 according to operation on the recommendation list in the terminal 20. The updated recommendation list is to be successively displayed by display operation of a new item, such as scroll operation, in the terminal 20. Because of this configuration, when the user successively views recommended items, the recommended items can be suitably supplied to the user. Specifically, a possibility that an item in which the user is expected to have low interest is inadvertently viewed by the user can be reduced.

As described in the foregoing, according to the terminal 20 in Embodiment 3, the terminal 20 performs processing including: collectively acquiring a recommendation list in which a plurality of items is arranged in an order in which the items are recommended, from the server 10; displaying the acquired recommendation list on a screen in a scrollable manner; accepting unnecessary-item selection operation of specifying an unnecessary item from items arranged in the recommendation list and displayed on the screen; identifying a low interest item, the low interest item being a similar item similar to the unnecessary item and being a non-displayed item not having been displayed on the screen, among items arranged in the recommendation list; and updating the recommendation list by decreasing a priority of the low interest item in the recommendation list.

Because of this configuration, the recommendation priority (display priority) in the recommendation list of an item in which the user is expected to have a low interest can be decreased mainly by the terminal 20 side, based on the unnecessary item selected by the user, and recommended items can be displayed on the terminal 20 from the recommendation list. Thus, it is possible to reduce a possibility that an item in which the user is expected to have a low interest is inadvertently viewed by the user when the user successively views recommended items.

In addition, since the recommendation priority of a low interest item is decreased, the other items are displayed in a preferential manner in the recommendation list. Since therefore, the other items are relatively likely to be viewed by the user, a recommendation list in which items in which the user is expected to be highly interested are arranged can be provided.

In addition, since the recommendation order of the recommendation list is changed within items that have not been displayed to the user, the recommendation order of the recommendation list can be changed without causing the user to notice the change.

### Variations

Note that the present disclosure is not limited to the above-described embodiments, and various modifications and applications are possible. For example, omission or replacement of a portion of the above-described embodiments, addition of an arbitrary component to the embodiments, or the like is possible.

In addition, in place of changing a recommendation priority of a low interest item in the recommendation list, a display form of a low interest item may be changed. For example, the display form of a low interest item in the recommendation list may be configured to be changed in such a way that the low interest item becomes inconspicuous. For example, display size of a low interest item in the recommendation list may be reduced or a low interest item may be excluded from the recommendation list. By the configuration as described above, it is possible to reduce a possibility that an item in which the user is expected to have a low interest is inadvertently viewed by the user when the user successively views recommended items.

Since when viewing operation (for example, a touch, a click, or the like on a link to detail information) of an item included in the recommendation list is performed, interest of the user in the item is supposed to be high, it may be configured such that a high interest item that is similar to the item and that has not been presented (has not been displayed) is identified in the recommendation list and a recommendation priority of the high interest item in the recommendation list is increased. Since by the configuration as described above, a possibility that an item in which the user has a high interest in the recommendation list is viewed by the user increases and an item in which the user has a low interest in the recommendation list is relatively made difficult for the user to view, items can be suitably recommended to the user.

In the above-described embodiments, when an unnecessary item is selected, the recommendation list is replenished with a new recommended item when the recommendation priority of the unnecessary item is decreased. Without being limited to the configuration, it may be configured such that the recommendation priority of the unnecessary item is decreased without replenishing the recommendation list with a new recommended item. That is, in step S19 in FIG. 3, step S59 in FIG. 7, and step S82 in FIG. 10, the processing of replenishing the recommendation list with a new recommended item may be omitted.

The processing of replenishing the recommendation list with a new recommended item may be configured to be performed at a different timing. For example, it may be configured such that when scroll operation of the recommendation list performed by the user is accepted, the recommendation list is replenished with a new recommended item. By the configuration as described above, when the user successively views the recommendation list, a recommended item can be successively added, and recommended items can be supplied without running out of recommended items.

The server 10 and the terminal 20 can be achieved using a general computer without depending on a dedicated device. For example, the server 10 and the terminal 20 that perform the above-described processing may be configured by installing, from a non-transitory recording medium storing a program to cause the computer to perform the above-described functions, the program in the computer. In addition, one server 10 may be configured by a plurality of computers operating in collaboration with one another.

In addition, as a method for supplying a computer with a program, an arbitrary method can be employed. For example, the program may be supplied via a communication line, a communication network, a communication system, or the like. For example, a non-transitory computer-readable recording medium storing a program for performing the above-described functions may be distributed.

In addition, when some of the above-described functions are provided by an operating system (OS), functions other than the functions provided by the OS are only required to be provided by a program.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### Disclosure Achieved by Present Embodiments

As described in the foregoing, the present embodiments achieve the disclosure described below.

### (Appendix 1)

An item list providing system including: a server; and a terminal, the item list providing system causing the server and the terminal to perform, in collaboration with each other, processing comprising:
generating a list in which a plurality of items is arranged in an order in which the items are recommended to a user;
presenting an item included in the generated list in accordance with an order in which the item is arranged in the list to a user;
identifying, when unnecessary-item selection operation of specifying an unnecessary item from the presented items is performed by the user, a low interest item, the low interest item being an item that is similar to the unnecessary item and that has not been presented to the user, among items arranged in the list; and
decreasing a priority of the low interest item in the list.

### (Appendix 2)

A server, comprising:
a generator to generate a list in which a plurality of items is arranged in an order in which the items are recommended to a user;
a provider to provide a terminal with an item included in the generated list in accordance with an order in which the item is arranged in the list and cause the terminal to display the provided item on a screen of the terminal;
a receiver to receive a report indicating that unnecessary-item selection operation of specifying an unnecessary item from items displayed on the screen is performed in the terminal, from the terminal;
an identifier to identify a low interest item, the low interest item being a similar item similar to the unnecessary item and being a non-displayed item not having been displayed on the screen, among items arranged in the list; and
an updater to decrease a priority of the low interest item in the list.

### (Appendix 3)

The server according to appendix 2, wherein
the report further includes display information indicating which one of items included in the list an item displayed on a screen of the terminal is, and
the server sets an item not indicated in the display information as the non-displayed item.

### (Appendix 4)

The server according to appendix 2 or 3, wherein
the server sets an item not having been provided to the terminal as the non-displayed item.

### (Appendix 5)

The server according to any one of appendices 2 to 4, wherein
the server newly recommends a new item that is not similar to the unnecessary item and that is not included in the list, and
the server adds the new item between a priority of an item having been provided to the terminal and a priority of the low interest item in the list.

### (Appendix 6)

A terminal, comprising:
an acquirer to acquire a list in which a plurality of items is arranged in an order in which the items are recommended, from a server;
a display to display the acquired list on a screen in a scrollable manner;
an acceptor to accept unnecessary-item selection operation of specifying an unnecessary item from items arranged in the list and displayed on the screen;
an identifier to identify a low interest item, the low interest item being a similar item similar to the unnecessary item and being a non-displayed item not having been displayed on the screen, among items arranged in the list; and
an updater to decrease a priority of the low interest item in the list.

### (Appendix 7)

The terminal according to appendix 6, wherein
the terminal, by reporting the unnecessary item to the server, causes the server to decrease a priority in which the reported item is recommended.

### (Appendix 8)

The terminal according to appendix 6 or 7, wherein
the terminal, by reporting the unnecessary item to the server, causes the server to identify a similar item similar to the unnecessary item among items arranged in the list.

### (Appendix 9)

The terminal according to any one of appendices 6 to 8, wherein
the terminal acquires a table of degrees of similarity between items arranged in the list in conjunction with the list, from the server and
the terminal calculates the degree of similarity between each of the non-displayed items and the unnecessary item from the table.

### (Appendix 10)

The terminal according to any one of appendices 6 to 9, wherein
the terminal acquires a feature vector of each of items arranged in the list in conjunction with the list, from the server and the terminal calculates a degree of similarity between each of the non-displayed items and the unnecessary item, based on the feature vectors.

### (Appendix 11)

The terminal according to appendix 9 or 10, wherein
the terminal, by comparing the calculated degree of similarity with a predetermined threshold value, identifies the similar item or identifies a predetermined number of or a predetermined ratio of items having the calculated degrees of similarity ranked higher as the similar items and the low interest items.

### (Appendix 12)

The terminal according to any one of appendices 6 to 10, wherein
the terminal causes the server to newly recommend a new item that is not similar to the unnecessary item, and
the terminal adds the new item to the list with a higher priority than the low interest item.

### (Appendix 13)

An item list providing method in an item list providing system including: a server; and a terminal, the item list providing method causing the server and the terminal to perform, in collaboration with each other, processing comprising:
generating a list in which a plurality of items is arranged in an order in which the items are recommended to a user;
presenting an item included in the generated list in accordance with an order in which the item is arranged in the list to a user;
identifying, when unnecessary-item selection operation of specifying an unnecessary item from the presented items is performed by the user, a low interest item, the low interest item being an item that is similar to the unnecessary item and that has not been presented to the user, among items arranged in the list; and
decreasing a priority of the low interest item in the list.

### (Appendix 14)

A program causing a computer to function as:
a generator to generate a list in which a plurality of items is arranged in an order in which the items are recommended to a user;
a provider to provide a terminal with an item included in the generated list in accordance with an order in which the item is arranged in the list and cause the terminal to display the provided item on a screen of the terminal;
a receiver to receive a report indicating that unnecessary-item selection operation of specifying an unnecessary item from items displayed on the screen is performed in the terminal, from the terminal;
an identifier to identify a low interest item, the low interest item being a similar item similar to the unnecessary item and being a non-displayed item not having been displayed on the screen, among items arranged in the list; and
an updater to decrease a priority of the low interest item in the list.

### (Appendix 15)

A program causing a computer to function as:
an acquirer to acquire a list in which a plurality of items is arranged in an order in which the items are recommended;
a display to display the acquired list on a screen in a scrollable manner;
an acceptor to accept unnecessary-item selection operation of specifying an unnecessary item from items arranged in the list and displayed on the screen;
an identifier to identify a low interest item, the low interest item being a similar item similar to the unnecessary item and being a non-displayed item not having been displayed on the screen, among items arranged in the list; and
an updater to decrease a priority of the low interest item in the list.

### INDUSTRIAL APPLICABILITY

According to the present disclosure, an item list providing system, a server, a terminal, an item list providing method, and a program capable of suitably recommending an item to a user can be provided.

### REFERENCE SIGNS LIST

10 Server
20 Terminal
30 Communication network
100 Item list providing system
11, 21 Processor
12, 22 Storage device
13, 23 Communication interface
14, 24 Input device
15, 25 Output device
110 Web browser
111 Item name
112 Item detail information
113 Recommendation list
114, 115 Scroll button
RI1, RI2, RI3, RI4, RI5, RI6, RI8, RI9 Item (recommended item)
DI Deleted item
ds Unnecessary-item selection button
rs Undo button

1. An item list providing system including: a server;
and a terminal, the item list providing system causing the server and the terminal to perform, in collaboration with each other, item list providing processing, the server and the terminal comprising:
at least one memory configured to store program code;
at least one processor configured to access the program code and operate as instructed by the program code, the program code including:
generating code configured to cause at least one of the at least one processor to generate a list in which a plurality of items is arranged in an order in which the items are recommended to a user;
presenting code configured to cause at least one of the at least one processor to present one or more items included in the generated list in accordance with an order in which the items are arranged in the list to a user;
identifying code configured to cause at least one of the at least one processor to identify, when unnecessary-item selection operation of specifying an unnecessary item from the presented one or more items is performed by the user, a low interest item, the low interest item being an item that is similar to the unnecessary item and that has not been presented to the user, among items arranged in the list; and
decreasing code configured to cause at least one of the at least one processor to decrease a priority of the low interest item in the list.

2. A server, comprising:
at least one memory configured to store program code;
at least one processor configured to access the program code and operate as instructed by the program code, the program code including:
generator code configured to cause at least one of the at least one processor to generate a list in which a plurality of items is arranged in an order in which the items are recommended to a user;
provider code configured to cause at least one of the at least one processor to provide a terminal with one or more items included in the generated list in accordance with an order in which the items are arranged in the list and cause the terminal to display the provided one or more items on a screen of the terminal;
receiver code configured to cause at least one of the at least one processor to receive a report indicating that unnecessary-item selection operation of specifying an unnecessary item from items displayed on the screen is performed in the terminal, from the terminal;
identifier code configured to cause at least one of the at least one processor to identify a low interest item, the low interest item being a similar item similar to the unnecessary item and being a non-displayed item not having been displayed on the screen, among items arranged in the list; and
updater code configured to cause at least one of the at least one processor to decrease a priority of the low interest item in the list.

3. The server according to claim 2, wherein
the report further includes display information indicating which one of items included in the list an item displayed on a screen of the terminal is, and
the program code includes code configured to cause at least one of the at least one processor to set an item not indicated in the display information as the non-displayed item.

4. The server according to claim 2, wherein
the program code includes code configured to cause at least one of the at least one processor to set an item not having been provided to the terminal as the non-displayed item.

5. The server according to claim 2, wherein
the program code includes:
code configured to cause at least one of the at least one processor to newly recommend a new item that is not similar to the unnecessary item and that is not included in the list, and
code configured to cause at least one of the at least one processor to add the new item between a priority of an item having been provided to the terminal and a priority of the low interest item in the list.

6. A terminal, comprising:
at least one memory configured to store program code;
at least one processor configured to access the program code and operate as instructed by the program code, the program code including:
acquirer code configured to cause at least one of the at least one processor to acquire a list in which a plurality of items is arranged in an order in which the items are recommended, from a server;
display code configured to cause at least one of the at least one processor to display the acquired list on a screen in a scrollable manner;
acceptor code configured to cause at least one of the at least one processor to accept unnecessary-item selection operation of specifying an unnecessary item from items arranged in the list and displayed on the screen;
identifier code configured to cause at least one of the at least one processor to identify a low interest item, the low interest item being a similar item similar to the unnecessary item and being a non-displayed item not having been displayed on the screen, among items arranged in the list; and
updater code configured to cause at least one of the at least one processor to decrease a priority of the low interest item in the list.

7. The terminal according to claim 6, wherein
the program code includes code configured to cause at least one of the at least one processor, by reporting the unnecessary item to the server, the server to decrease a priority in which the reported item is recommended.

8. The terminal according to claim 6, wherein
the program code includes code configured to cause at least one of the at least one processor, by reporting the unnecessary item to the server, to cause the server to identify a similar item similar to the unnecessary item among items arranged in the list.

9. The terminal according to claim 6, wherein
the program code includes:
code configured to cause at least one of the at least one processor to acquire a table of degrees of similarity between items arranged in the list in conjunction with the list, from the server and
code configured to cause at least one of the at least one processor to calculate the degree of similarity between each of the non-displayed items and the unnecessary item from the table.

10. The terminal according to claim 6, wherein
the program code includes:
code configured to cause at least one of the at least one processor to acquire a feature vector of each of items arranged in the list in conjunction with the list, from the server and
code configured to cause at least one of the at least one processor to calculate a degree of similarity between each of the non-displayed items and the unnecessary item, based on the feature vectors.

11. The terminal according to claim 9, wherein
the program code includes code configured to cause at least one of the at least one processor, by comparing the calculated degree of similarity with a predetermined threshold value, to identify the similar item or to identify a predetermined number of or a predetermined ratio of items having the calculated degrees of similarity ranked higher as the similar items and the low interest items.

12. The terminal according to claim 6, wherein
the program code includes:
code configured to cause at least one of the at least one processor to cause the server to newly recommend a new item that is not similar to the unnecessary item, and
code configured to cause at least one of the at least one processor to add the new item to the list with a higher priority than the low interest item.

13. An item list providing method in an item list providing system including: a server; and a terminal, the server and the terminal having at least one processor, the item list providing method causing the server and the terminal to perform, in collaboration with each other, processing comprising:
generating a list in which a plurality of items is arranged in an order in which the items are recommended to a user;
presenting one or more items included in the generated list in accordance with an order in which the items are arranged in the list to a user;
identifying, when unnecessary-item selection operation of specifying an unnecessary item from the presented items is performed by the user, a low interest item, the low interest item being an item that is similar to the unnecessary item and that has not been presented to the user, among items arranged in the list; and
decreasing a priority of the low interest item in the list.

14. A non-transitory computer-readable information recording medium storing a program causing a computer to:
generate a list in which a plurality of items is arranged in an order in which the items are recommended to a user;
provide a terminal with one or more items included in the generated list in accordance with an order in which the items are arranged in the list and cause the terminal to display the provided one or more items on a screen of the terminal;
receive a report indicating that unnecessary-item selection operation of specifying an unnecessary item from items displayed on the screen is performed in the terminal, from the terminal;
identify a low interest item, the low interest item being a similar item similar to the unnecessary item and being a non-displayed item not having been displayed on the screen, among items arranged in the list; and
decrease a priority of the low interest item in the list.

15. A non-transitory computer-readable information recording medium storing a program causing a computer to:
acquire a list in which a plurality of items is arranged in an order in which the items are recommended;
display the acquired list on a screen in a scrollable manner;
accept unnecessary-item selection operation of specifying an unnecessary item from items arranged in the list and displayed on the screen;
identify a low interest item, the low interest item being a similar item similar to the unnecessary item and being a non-displayed item not having been displayed on the screen, among items arranged in the list; and
an updater to decrease a priority of the low interest item in the list.
